(19) United States
(12) Patent Application Publication
(10) Pub. No.: US 2013/0105650 A1
(43) Pub. Date: May 2, 2013

(54) STEMWARE RETAINING HOLDER

(71) Applicant: Leonard Cohen, San Luis Obispo, CA (US)

(72) Inventor: Leonard Cohen, San Luis Obispo, CA (US)

(21) Appl. No.: 13/470,149

(22) Filed: May 11, 2012

Related U.S. Application Data
(60) Provisional application No. 61/587,536, filed on Jan. 17, 2012.
(60) Provisional application No. 61/552,993, filed on Oct. 28, 2011.

(51) Int. Cl. A47G 29/00; F16B 2/22; B23P 11/00; F16B 2/20

(52) U.S. Cl. 248/229.26; 248/316.7; 29/525.08

(57) ABSTRACT

Stemware retaining holders that secure stemware to a serving tray are described herein. The stemware retaining holder is coupled to a tray and engages with stemware. The stemware is held to the tray by a downward force applied by the stemware retaining holder against the stemware base.

### RELATED APPLICATION INFORMATION

This patent claims priority from the following provisional patent applications: Application No. 61/587,536 filed Jan. 17, 2012 entitled Stemware Retaining Holder and Application No. 61/552,993 filed Oct. 28, 2011 entitled Stemware Retaining System, the entire contents of which are expressly incorporated by reference herein.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to a stemware holder and, more particularly to a device that holds stemware glasses to a tray.

2. Description of the Related Art

Stemware such as champagne flutes, wine glasses, martini glasses and the like, are inherently unstable because the liquid is held toward the top of the glass with an elongate stem extending to the base, causing the stemware to be top-heavy. Accordingly, stemware may topple over easily. Furthermore, in restaurants and bars, servers often deliver several glasses on a tray, and stemware may topple over as the tray is carried. In some instances, this may cause the contained beverages to spill on the ground or on patrons, and the stemware may break when tipped over.

Some trays have a non-slip mat that helps prevent the glasses from sliding on the tray. However, the stemware can still topple over even with the non-slip mat. Specially designed trays have been made that have cutouts in the tray that hold the stemware at the top of the stem. However, these specially made stemware trays may not hold a variety of other items, such as regular glasses or dishes.

### DESCRIPTION OF THE DRAWINGS

FIG. 1 is a perspective view illustrating a stemware retaining holder coupled to a stemware glass and tray.

FIG. 2 is a close-up perspective view illustrating a stemware retaining holder coupled to a tray.

FIG. 3 is a close-up perspective view illustrating a stemware retaining holder.

FIG. 4 is perspective view illustrating a stemware retaining holder coupled to a tray and before coupling with a stemware glass.

FIG. 5 is perspective view illustrating a stemware retaining holder coupled to a tray and after coupling with a stemware glass.

FIG. 6 is perspective view illustrating another embodiment of a stemware retaining holder coupled to a stemware glass and tray.

FIG. 7 is perspective view illustrating another embodiment of a stemware retaining holder coupled to a stemware glass and tray.

### DETAILED DESCRIPTION

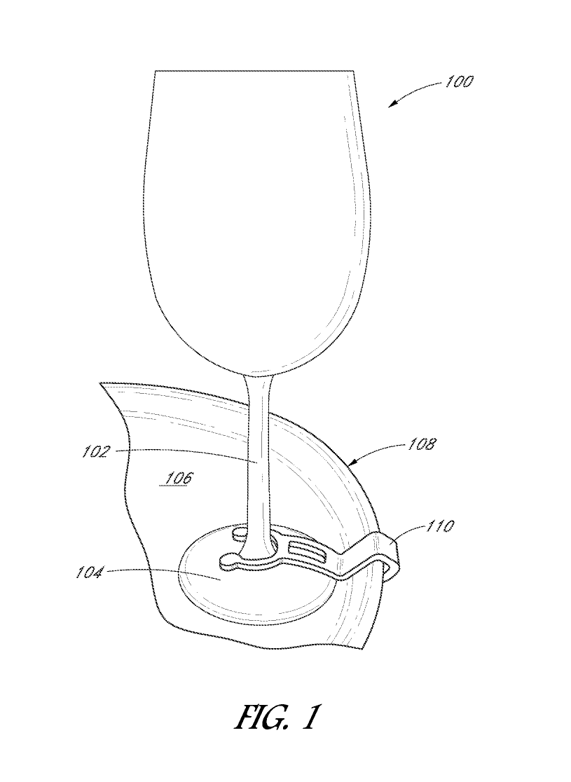

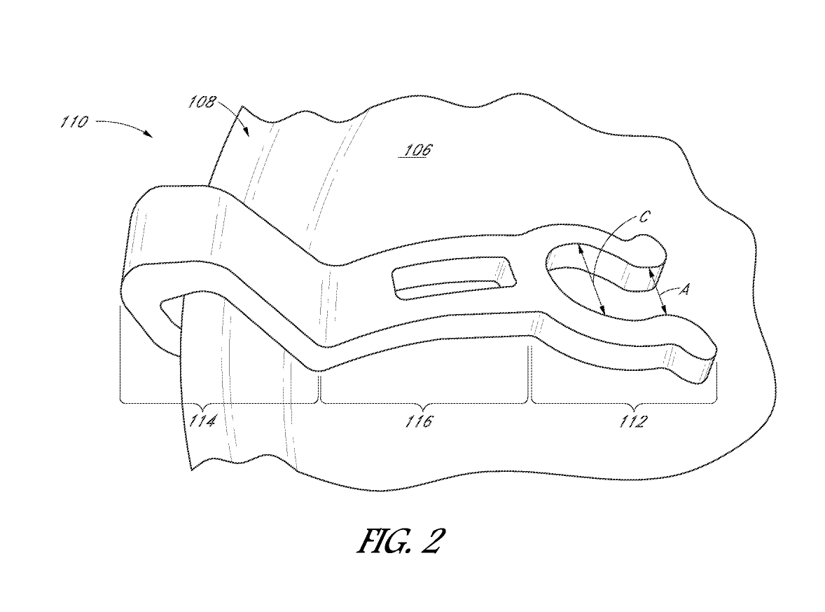

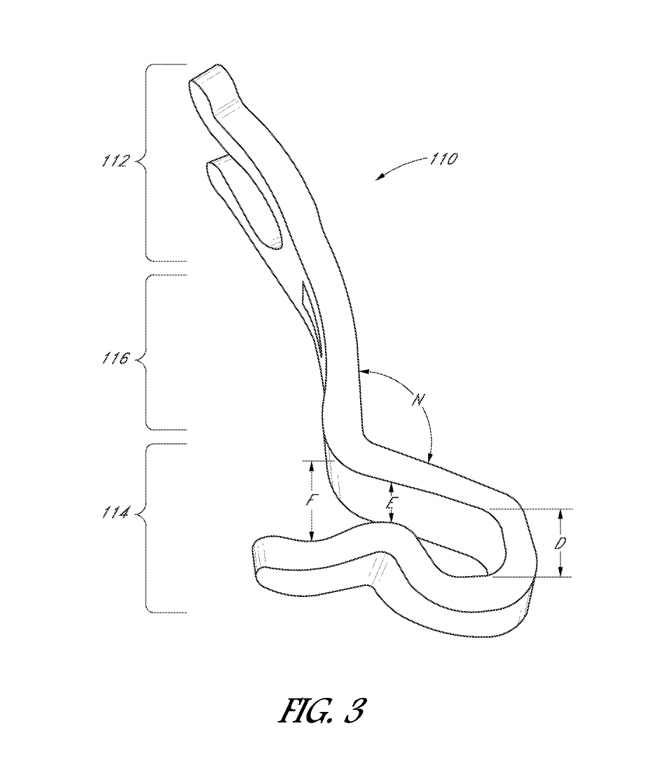

Stemware retaining systems that hold stemware on a serving tray are described herein. FIG. 1 illustrates an embodiment of a stemware retaining holder 110 securing a stemware glass 100 on a typical serving tray 106. FIG. 2 illustrates the stemware retaining holder 110 on a tray 106 without the stemware glass 100. FIG. 3 illustrates a side view of the stemware retaining holder 110 removed from the tray 106 so that the configuration of the holder may be readily appreciated. Although the term stemware glass is used, this disclosure includes use of the stemware retaining holder 110 on stemware made from glass, crystal, plastic, metal or other material used in making stemware.

With continued reference to FIG. 1, a serving tray 106 may have removably coupled thereto a stemware retaining holder 110 that is configured to secure a stemware glass 100 to the tray 106. In the illustrated embodiment, the stemware retaining holder 110 holds the lower portion of the stemware glass 100, which includes a stem 102 and base 104.

As illustrated in FIGS. 2 and 3, the stemware retaining holder 110 will be described with three portions, a receiver 112, a clip 114 and an extension 116 therebetween. It should be understood that in some embodiments, the stemware retaining holder may have additional portions or fewer portions.

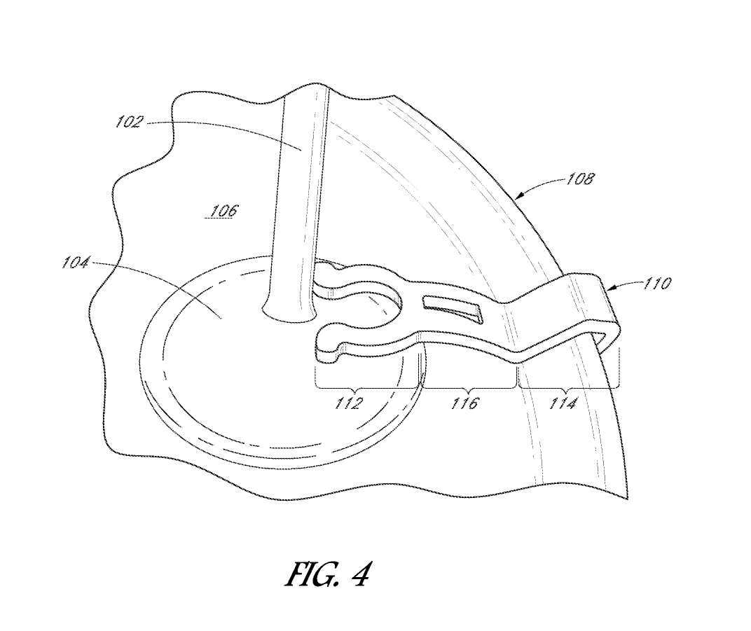

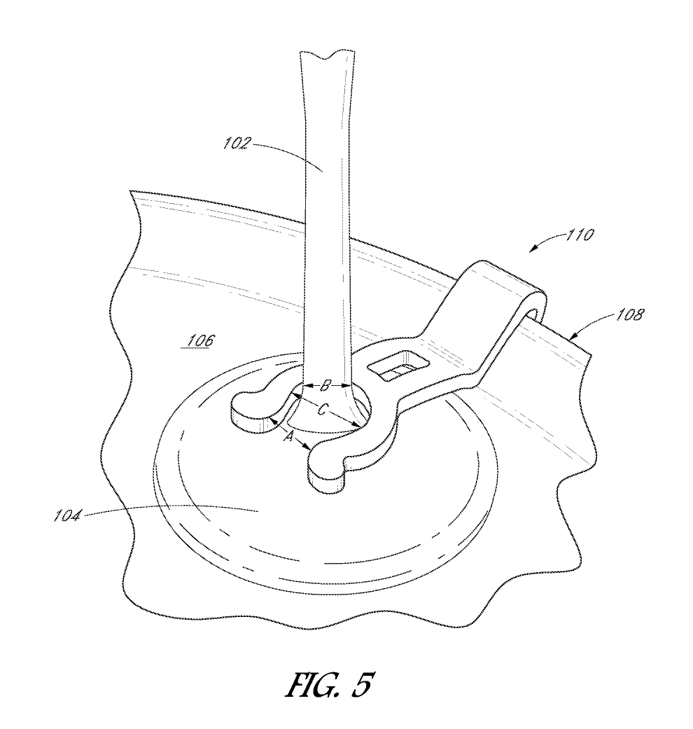

FIG. 4 illustrates an embodiment of the stemware retaining holder 110 receiving a stemware glass 100. With the stemware retaining holder 110 already attached to a tray 106, the glass 100 may be placed on the tray and slid toward the stemware retaining holder 110. The receiver 112 of the stemware retaining holder 110 secures the stem 102 of the glass 100 while the base 104 slides under the receiver 112 and extension 116 portions of the stemware retaining holder 110. The receiver 112 may be configured to be disposed around the stem 102 wherein the receiver 112 may have an opening of width A that accepts the stem 102, as illustrated in FIG. 5.

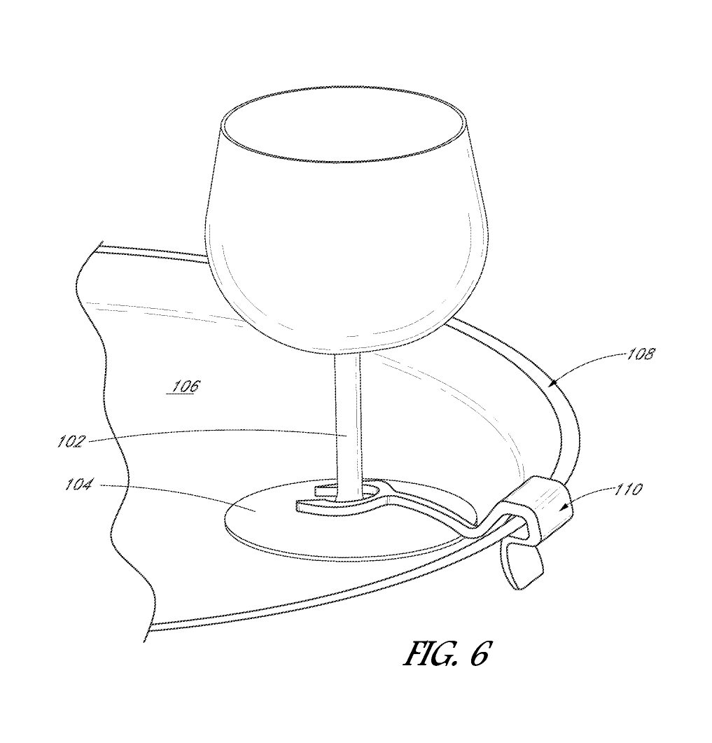

The extension 116 is configured to be apposed the base 104 of the glass 100. As discussed further below, the stemware retaining holder 110 may deflect when the glass 100 is slid under the receiver 112 and extension 116, such that the stemware retaining holder 110 applies a downward force or pressure against the upper surface of the base 104. The extension 116 portion may be slightly curved to generally conform to the curved contour of many stemware bases, as illustrated in FIG. 3. In the illustrated embodiment, the extension 116 portion is generally the same width as the clip 114 portion, with a cutout in the middle. In other embodiments, the extension 116 may not have a cutout. The extension 116 may have a smaller width than the clip 114, such as a rod-like shape, as illustrated in the embodiment of FIG. 6.

The stemware glass 100 is held to the tray 106 by the downward force applied by the stemware retaining holder 110 against the stemware base 104, as illustrated in FIGS. 1 and 5. When the stemware glass 100 is positioned under the stemware retaining holder 110, the height of the base 104 may be larger than the distance between the tray 106 and the receiver 112. The base 104 may push the receiver 112 portion upward and deflect the stemware retaining holder 110. Preferably, the stemware retaining holder 110 is made of a resilient material so that the stemware retaining holder 110 may exert a return force on the base 104, producing a downward force that holds the stemware glass 100 to the tray 106.

With reference to FIG. 3, the configuration of stemware retaining holder 110 and in particular the angle N between the extension 116 and the clip 114 affects the amount of force that the stemware retaining holder 110 exerts on the stemware base 104 to hold the base 104 against the tray 106. As the angle N increases, the distance between the tray 106 and the receiver 112 decreases, and the base 104 of the stemware glass 100 will deflect the stemware retaining holder 110 more. The more the stemware retaining holder 110 is deflected, the greater the downward return force that is exerted on the base 104. In some embodiments, the angle N may be approximately 105 degrees. In some embodiments, the angle N may be at least approximately 90 degrees and/or less than or equal to approximately 180 degrees. When the tray has a smooth or flat edge, the angle N may be approximately 180 degrees so that the clip can slide over the flat edge of the tray and hold onto the tray.

The stiffness of the stemware retaining holder 110 also affects the amount of force exerted by the stemware retaining holder 110. A stiffer material will provide more downward return force per unit of deflection. In some embodiments, the downward force applied to the base 104 can be provided by a spring that is disposed between the extension 116 and the clip 114.

The stemware retaining holder 110 may be removably attached to a tray 106 by clip 114, as illustrated in FIG. 2. The clip 114 portion may be attached to the tray 106 by pressing the clip 114 onto a lip 108 of the tray 106. Preferably, the clip 114 may rigidly attach to the lip 108 of the tray 106. In embodiments where the tray has a flat edge, the clip may slide over the edge of the tray and be held in place by clamping or compression of the tray between the sides of the clip. In some embodiments, the stemware retaining holder 110 may be attached to trays and other surfaces through other methods, such as adhesives, fasteners, welding, straps, Velcro®, etc.

Referring now to FIGS. 2 and 3, the shape of the clip 114 portion may be configured to fit onto the lip 108 of the tray 106. The opening F of the clip 114 may be sufficiently large to fit over the lip 108 of the tray 106. The opening F may be approximately 10 millimeters. In some embodiments, the opening F may be at least approximately 5 millimeters and/or less than or equal to approximately 25 millimeters. The clip 114 may have a constricted portion E that may be generally the same size as the thickness of the lip 108 region of the tray 106. The constricted portion E helps clip 114 to grab and secure onto the tray 106. The constricted portion E may be approximately 3 millimeters in width. In some embodiments, the constricted portion E may be at least approximately 1 millimeter and/or less than or equal to approximately 10 millimeters. The shape and size of the cavity D may be configured to wrap around the edge of the lip 108 of the tray 106. The cavity D may be approximately 7 millimeters in width. In some embodiments, the cavity D may be at least approximately 5 millimeters and/or less than or equal to approximately 15 millimeters. The size and shape of D, E and F are configured to allow for both easy attachment of the stemware retaining holder 110 onto the tray 106 and secure engagement of the stemware retaining holder 110 to the tray 106. In some embodiments, the shape, size and configuration of the clip 114 may be different to accommodate different serving trays as well as other trays. The clip may be configured to be coupled to other objects besides trays, such as chair armrests, tables, countertops, etc. In these embodiments, the clip may have a different shape and design so that it is configured to secure to the armrests or other objects. The disclosure herein and the figures show a non-limiting example of a stemware retaining holder 110.

The stemware retaining holder 110 includes a receiver 112 that may be generally C-shaped, as illustrated in FIGS. 2 and 5. The opening A of the receiver 112 may have a width that is approximately the same width as the diameter B of the stem 102 of the glass 100. The opening A may have a width that is slightly less than the diameter B of the stem 102 such that some force is needed to push and retain the stemware glass 100 to the stemware retaining holder 110. The opening A may have a width that is larger than the diameter B of the stem 102, and the downward force of the stemware retaining holder 110 against the base 104 is sufficient to hold the glass 100 on the tray 106. The opening A may be approximately 10 millimeters in width. In some embodiments, the opening A may be at least approximately 5 millimeters and/or less than or equal to approximately 25 millimeters.

The center cavity C of the receiver 112 may have a width that is larger (by, for example, 1-5 millimeters) than the diameter B of the stem 102. The glass 100 may be held in the center cavity by the interference fit between the stem 102 and opening A, and/or the downward force exerted by the stemware retaining holder 110 on the base 104, as described above. The center cavity C may be approximately 18 millimeters in width. In some embodiments, the center cavity C may be at least approximately 10 millimeters and/or less than or equal to approximately 25 millimeters.

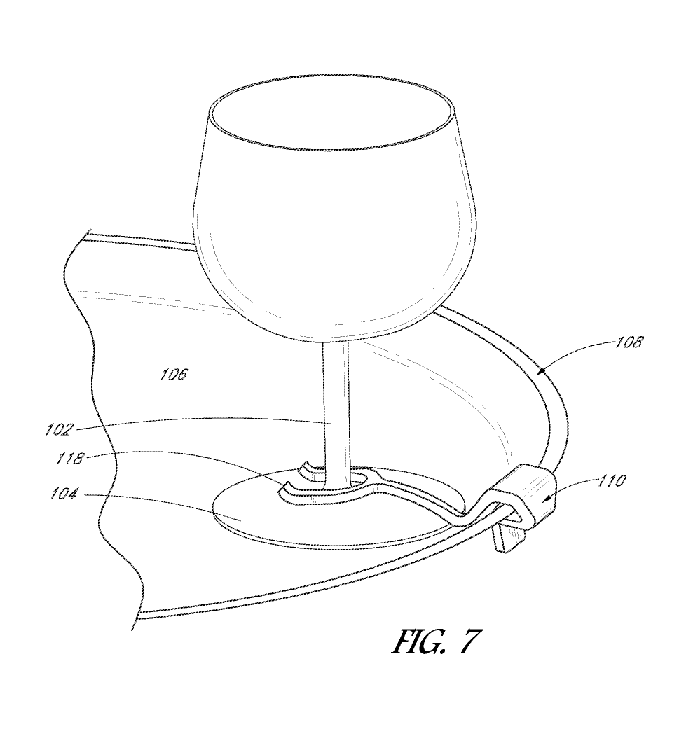

In some embodiments, the receiver 112 may have an opening A that is substantially the same width as the center cavity C, as best illustrated in FIG. 7. The receiver may be generally U-shaped. The tips 118 of the receiver 112 may be curved so that when a glass 100 is slid toward the receiver 112, the curved tips 118 can guide the receiver 112 over the base of the glass 100, allowing easy and efficient coupling of the glass 100 with the stemware retaining holder 110.

Although the figures show a single stemware retaining holder 110 coupled to the tray 106, multiple stemware retaining holders 110 may be used in combination with a tray 106. In some embodiments, stemware retaining holders 110 may be permanently or semi-permanently attached to trays, such as through fasteners, adhesives, plastic welding, etc. The overall length of stemware retaining holder 110 is preferably long enough so that the base 104 of the glass 100 does not interfere with the lip 108 of the tray 106 when the glass 100 is coupled with the stemware retaining holder 110. The overall length of the stemware retaining holder 110 may be longer than the embodiments shown in the figures so that the stemware glass 100 can be positioned closer to the center of the tray 106. The overall length of the stemware retaining holder 110 may be approximately 86 millimeters. In some embodiments, the overall length may be at least approximately 40 millimeters. The length of the stemware retaining holder 110 may be adjustable, such as for example with a telescoping extension 116 portion.

The stemware retaining holder 110 may be made of a strong resilient material such as plastic, nylon, glass, fiberglass, composites, metal or other suitable material that is preferably resilient, strong and durable. The stemware retaining holder 110 or portions thereof may be coated with rubber or other coating to assist in keeping the stemware base secured and held under the stemware retaining holder 110, and reduce the possibility of the base 104 of the stemware glass 100 from slipping out from under the stemware retaining holder 110. The tray may be made of glass, metal, plastic or wood, and in some embodiments may have rubber or plastic and/or may be textured to reduce the possibility of the stemware glass 100 from slipping out from under the stemware retaining holder 110.

The tray 106 may be round, square, rectangular or any other shape, and may be regular or irregular in shape. The tray 106 may be a serving tray typically used by a restaurant server or bartender. The tray 106 may be augmented with a hand or finger holder on the bottom side of the tray, such as a strap. The hand or finger holder may be made of cloth, nylon, canvas, leather, or other suitable material. The hand or finger holder may be connected to the tray by rivets, screws, adhesives, staples, hook and loop fasteners or a combination of different types of fastening techniques. The hand or finger holder may be able to be flush with the bottom of the tray for storage and extend when in use to maintain the hand and/or fingers against the tray. The hand or finger holder may provide an opening for two, three or four fingers to fit through, or for an entire hand to fit through. The hand or finger holder advantageously allows a user to better control the tray when delivering beverages (with or without the stemware retaining holders 110) and/or food items placed on the tray. The tray may be a fold down or pull up stowed or stowable tray used in an airplane, bus, train or boat.

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments. Additionally, it will be recognized that the methods described herein may be practiced in different sequences, and/or with additional devices as desired. Such alternative embodiments and/or uses of the methods and devices described above and obvious modifications and equivalents thereof are intended to be included within the scope of the present invention. Thus, it is intended that the scope of the present invention should not be limited by the particular embodiments described above, but should be determined only by a fair reading of the claims that follow.

What is claimed is:

1. A stemware retaining holder comprising:
a receiver portion configured to couple with a stem of the stemware;
an extension portion configured to be apposed to a base of the stemware;
a clip portion configured to secure to an object;
wherein the stemware retaining holder is configured to apply a downward force on the base of the stemware when the clip is secured to the object.

2. The stemware retaining holder of claim 1, wherein the receiver is U-shaped with an opening to receive the stem.

3. The stemware retaining holder of claim 2, wherein the width of the opening of the U-shaped receiver is smaller than a diameter of the stem.

4. The stemware retaining holder of claim 2, wherein the width of the opening of the U-shaped receiver is approximately the same as a diameter of the stem.

5. The stemware retaining holder of claim 1, wherein the extension portion is curved to conform to the contour of the base.

6. The stemware retaining holder of claim 1, wherein a length of the extension portion is adjustable.

7. The stemware retaining holder of claim 1, wherein the clip portion is configured to removably attach to a lip of a tray.

8. The stemware retaining holder of claim 1, wherein the clip portion is configured to removably attach to an edge of a tray.

9. The stemware retaining holder of claim 1, wherein the clip portion is configured to attach to a chair armrest.

10. The stemware retaining holder of claim 1, wherein the clip portion is configured to rigidly attach to the object.

11. The stemware retaining holder of claim 1, wherein the clip portion is configured to permanently attach to the object.

12. The stemware retaining holder of claim 1, wherein the angle between the extension portion and the clip portion is approximately 105 degrees.

13. The stemware retaining holder of claim 1, wherein the angle between the extension portion and the clip portion ranges from approximately 90 degrees to approximately 180 degrees.

14. The stemware retaining holder of claim 1, wherein the stemware retaining holder is made of a resilient material.

15. The stemware retaining holder of claim 1, wherein the stemware retaining holder is made of plastic.

16. The stemware retaining holder of claim 1, wherein the stemware retaining holder is made of metal.

17. The stemware retaining holder of claim 1, wherein the stemware retaining holder is made of glass.

18. The stemware retaining holder of claim 1, wherein the stemware retaining holder is coated with rubber.

19. The stemware retaining holder of claim 1, further comprising a spring between the extension portion and the clip portion.

20. A method of using a stemware retaining holder comprising:
sliding a stemware retaining holder over an edge of a tray so that the stemware retaining holder is coupled to the edge of the tray
sliding a stemware item toward the stemware retaining holder until a stem of the stemware item is positioned in a receiver of the stemware retaining holder such that the stemware retaining holder applies a downward force to a base of the stemware, the stemware retaining holder holding the base of the stemware against a surface of the tray.
